(19) United States
(12) Patent Application Publication
(10) Pub. No.: US 2008/0245799 A1
(43) Pub. Date: Oct. 9, 2008

(54) Folded Alcohol Beverage Bag and Method

(76) Inventors: Ian Anderson, Cambridge (GB); Albert Wauters, Destelbergen (BE)

Correspondence Address: Levy & Grandinetti, 1725 K Street N.W., Suite 408, Washington, DC, 20006-1419, US

(21) Appl. No.: 11/596,985

(22) PCT Filed: May 20, 2005
(86) PCT No.: PCT/IB05/01378

§ 371 Date: Feb. 4, 2008

(30) Foreign Application Priority Data
May 20, 2004 (GB) 0411293.4

(51) Int. Cl. B65D 25/14; B65B 31/00; B65B 41/18; B31B 7/00

(52) U.S. Cl. 220/495.06; 53/512; 53/175; 493/93

(57) ABSTRACT

A bag (10) adapted for insertion into a container and a method of folding the bag is disclosed. The bag has two panels (14, 16) and a neck portion (30) passing between the panels. The neck portion has a spear portion (34) extending into the bag between the panels through which an alcohol beverage may pass into and out of the bag. The bag has a first plurality of folds (50) on each of the panels extending orthogonal to the spear. A first side of the bag is folded inwards over itself in a first spiral-like manner (70) in a plurality of folds sections along fold lines extending parallel to the spear. A second side of the bag is folded inwards over itself in a second spiral-like manner (78) in plurality of fold sections along fold lines extending parallel to the spear.

### FIELD OF THE INVENTION

The present invention relates to a method of preparing an alcohol beverage bag for insertion into a container and a bag so folded.

### BACKGROUND OF THE INVENTION

It is known to construct an alcohol bag in a manner that when the bag is filled with an alcohol beverage, such as, for example, beer or wine, the bag resembles the shape of the container in which the bag is housed.

In applications where the bag is used to contain beer, the bags are typically housed in a keg having a generally cylindrical shape. The bag has a neck portion secured to the keg. The bag is deflated, past through a keg aperture and then filled with beer. After the beer is dispensed from the keg, the bag is removed through the aperture. Typically, the bag comprises two circular panels spaced apart by a cylindrical shaped sheet. The sheet is welded at its ends to the circular panels to form two end seams. The sheet is also welded along its length to form a third seam. A fourth seam is made where the neck passes through one of the circular panels.

Alternatively the bag may comprise a first panel and a second panel having peripheral edges welded together to form a first seam. Each of the first and second panels has an area larger than a cross-sectional area for the keg. This sizing of the panels relative to the keg cross-sectional area permits the panels to be forced apart during bag filling so as to expand the bag internal space to approximate the volume of the keg. The bag has an open neck member passing through an aperture of the first panel or in a seam between panels. The bag is then welded to the neck member.

A problem occurs during bag insertion into the keg. Typically, the keg has an aperture for receiving the bag where the size of the aperture corresponds to the size of the bag neck member. Thus the size of the aperture is much smaller than the bulk of the bag. This makes it difficult to insert the bag into the keg. Further care must be taken not to rupture the bag during its installation in the keg. While it is known to fold the bag to insert the bag into the keg, the folded bag must be able to expand readily during filling within the container without having rupturing the bag. Further the folds of the bag need to be made in a way that as the bag unravels, no kinks are present that prevent beer from filling the entire contents of the bag. Accordingly, there is a need for a bag folded in a manner that permits the bag to be readily inserted into a container and which unravels during filing of the bag to readily expand within the container.

### SUMMARY OF THE INVENTION

The present invention relates to a folded bag adapted for insertion into a container and a method of folding the bag where the bag is able to readily unravel during filling of the bag so as to expand and fill the space of the container.

In accordance with the present invention, the bag has two panels and a neck portion passing between the panels. The panels may comprise rectangular panels welded together along seams or a bag of other construction flattened into two opposing panels. The neck portion has a spear portion extending into the bag between the panels through which beverage passes into and out of the bag. The bag has a first plurality of folds on each of the panels extending orthogonal to the spear. A first side of the bag, with the first plurality of folds, is folded inwards over itself in a first spiral-like manner in a plurality of fold sections along fold lines extending parallel to the spear. A second side of the bag, with the first plurality of folds, is folded inwards over itself in a second spiral-like manner in a plurality of fold sections along fold lines, extending parallel to the spear.

Preferably the bag has a releasable fastener at least partially surrounding the bag for maintaining the bag in its folded state for insertion into the container. The fastener is adapted to release from the bag during filing of the bag whereby the bag unravels. Preferably the first and second spiral-like manners spiral in the same direction. Preferably two folded corners on the first side of the bag are folded into the center of the bag to form two triangle flaps having adjacent side walls.

The folded bag of the present invention may be made in accordance with the method involving the steps of:

a) folding the bag into a first folded state by folding each of the panels along a plurality of fold lines that extend orthogonal to the spear;

b) folding the bag into a second folded state by folding a first side of the bag in the first folded state inwards over itself in a first spiral-like manner in a plurality of fold sections along fold lines extending parallel to the spear;

c) folding the bag into a third folded state by folding a second side of the bag in the second folded state inwards over itself in a second spiral-like manner in a plurality of fold sections along fold lines extending parallel to the spear; and,

d) applying a releasable fastener to the bag in the third folded state so as to maintain the bag in the third folded state for insertion into the container.

### BRIEF DESCRIPTION OF THE DRAWINGS

For a better understanding of the nature and objects of the present invention reference may be had to the accompanying diagrammatic drawings in which:

FIG. 1 is a perspective view of the bag of the present invention shown in a flattened condition;

FIG. 2 is a section view of the a top portion of the bag of the present invention shown with first folded branches;

FIG. 3 is a side view of the bag shown with first folded branches 2;

FIG. 4 is a side sectional view of the bag with first folded branches;

FIG. 5 is a view of the bag shown with one side thereof having folded corner flaps; and,

FIG. 6 is a plan view of the bag showing both of the sides folded in a spiral like manner and, with a perforated tape attached to the bag.

### DETAILED DESCRIPTION OF THE INVENTION

Referring to FIG. 1 there is shown a bag 10 having a preferred construction for use in a container. The bag 10 is suitable for use for housing an alcohol beverage and in the preferred embodiment for housing beer. The bag 10 is pliable and preferably comprises two layers of plastic material or panels 14 and 16 which are welded together along their peripheral edges 20. The panels 14 and 16 are generally rectangular in shape. It should be understood that each panel may comprise one or more layers of plastic material joined along the peripheral edges and that these layers are not necessarily laminated together.

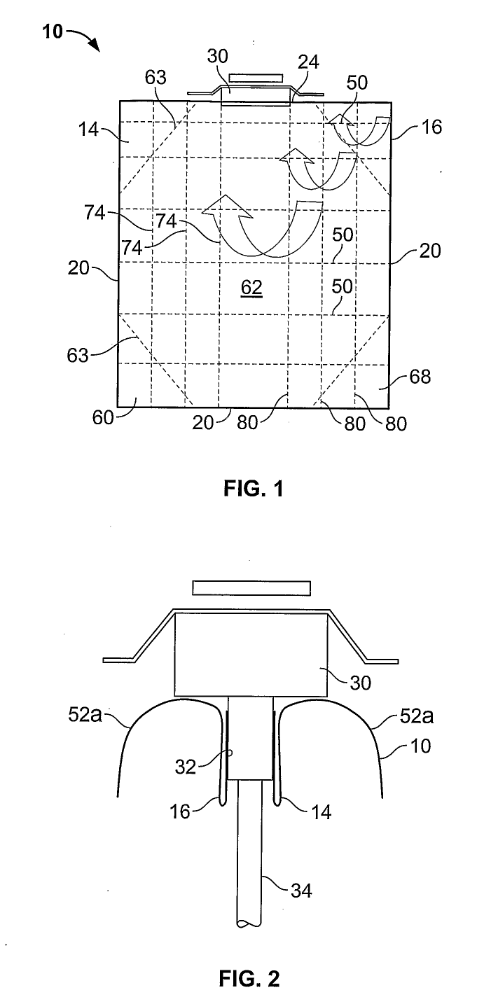

The bag 10 has an aperture 24 positioned through a seam portion between the first and second panels 14, 16. A neck portion 30 extends through the aperture 24 and is secured to the panels 14, 16 by a weld 32 (see FIG. 2). The neck 30 typically comprises a rubber like material and has a spear or tube passageway 34 (FIG. 2) through which alcohol or beer is filled into the space or volume between the panels 14 and 16.

In accordance with the present invention it should be understood that the neck portion 30 of the bag 10 of FIG. 1 typically has a cross-sectional area or a diameter in this preferred embodiment that corresponds to an aperture of a container in which the bag is to be inserted. In some embodiments, securing rings or intermediate rings (not shown) surround the neck 30 so as to seal or positively locate the neck 30 within the container. It should be understood that the cross-sectional area of the bag 10 as shown in FIG. 1 below the neck 30 is sufficiently larger than the cross-sectional area or diameter of the container aperture. It should also be understood that the Figures utilized herein are for the purposes of illustration and that the exact dimensions of the cross-sectional areas of the neck 30 of bag 10 are not to scale.

In order to effectively insert and install the bag 10 within the container, the method of the present invention involves preparing the bag 10 for insertion into the container.

The first step is to place the bag 10 with the panels 14, 16 in the adjacent position shown in FIG. 1. At this stage a vacuum is applied through the neck portion 30 to partially evacuate the bag 10. It is important that some air remain in the bag 10 to allow each of the panels 14, 16 to be separated from each other to provide the first folding step.

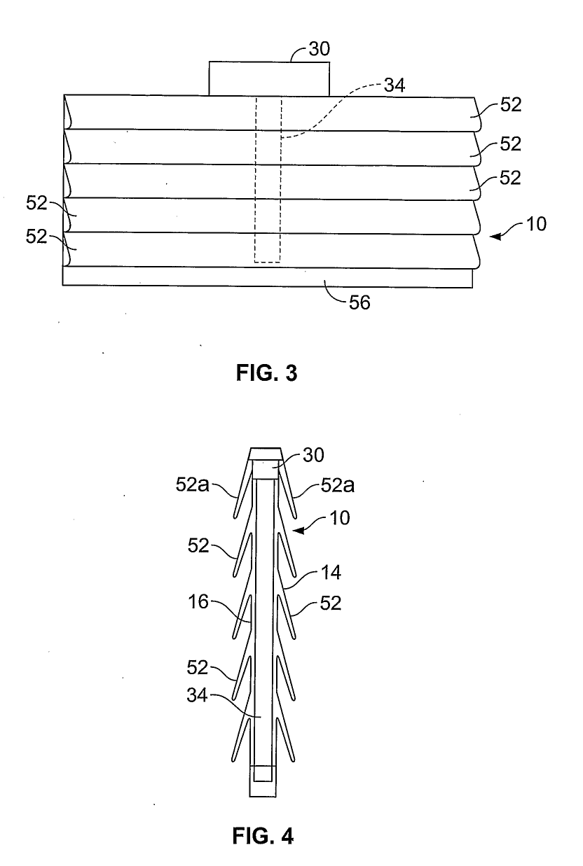

The first folding step is to fold the bag 10 into a first folded state by folding each of the panels 14, 16 along a plurality of fold lines 50 that extend orthogonal to the spear 34. The first folded state is shown in FIGS. 2, 3 and 4 where each of the panels 14, 16 has a plurality of folded branches 52 that partially overlap adjacent branches 52 as best seen in FIG. 4. Each of the panels 14, 16 has a first folded branch 52a that is closely adjacent the neck portion 34 as seen in FIG. 2. The folded branches 52 are equidistant from in flap and are uniform across the width of the bag 10 as best seen in FIG. 3. The spear 34 extends adjacent a bottom portion 56 of the bag 10 in the first folded state. In the embodiment shown, there are five such folded flaps or branches 52.

At this stage a further vacuum is applied through the neck portion 34 to further evacuate bag 10. Preferably, the bag is evacuated to a pressure of −0.7 bar.

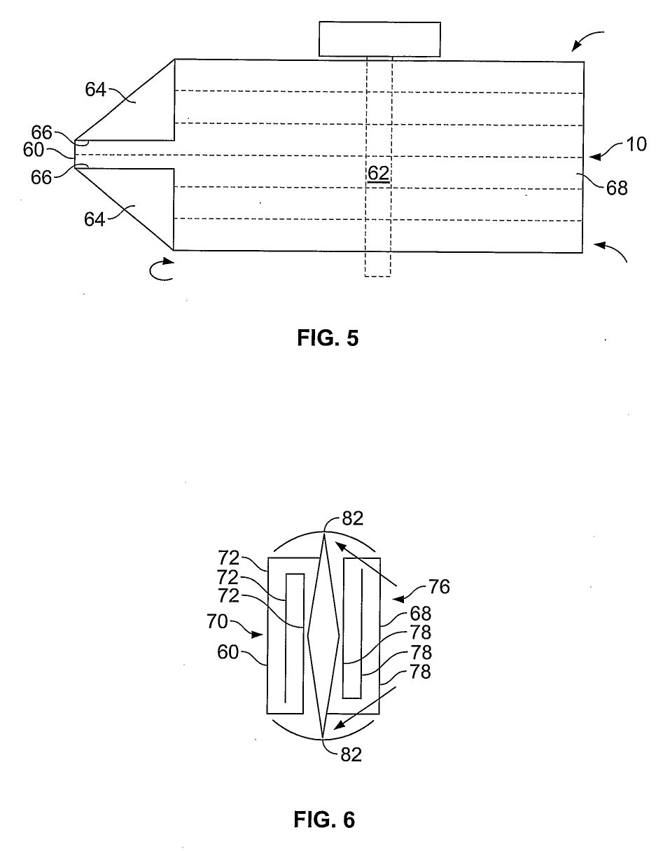

Next, the bag 10 is folded into a second folded state as shown in FIG. 5 by folding corners 58 of a first side 60 of the bag 10 in the first folded state into the center 62 of the bag 10 along fold lines 63 (see FIG. 1) to form two triangle flaps 64 having adjacent side walls 66. In the illustrated embodiment this corner flap folding occurs only on the first side. However, in alternative embodiments, the similar corner flap folding may occur on second side 68 of the bag 10. These additional two corner flaps may be on the same side of the bag 10 as the first flaps 64 or on the other side of the bag 10.

Next, as best seen in FIG. 6, the bag 10 is folded into a third folded state, by folding the first side 60 of the bag in the second folded state inwards over itself in a first spiral-like manner generally shown at 70 in a plurality of fold sections 72 along fold lines 74 (see FIG. 1). The fold lines 74 extend parallel to the spear 34. Next, as best seen in FIG. 6, the bag 10 is folded into a fourth folded state by folding the second side 68 of the bag inwards over itself in a second spiral-like manner generally shown at 76 in a plurality of fold sections 78 along fold lines 80 (see FIG. 1). The fold lines 80 also extend parallel to the spear 34. It should be understood that the fold sections 72, 78 while generally spiraling inwardly do not form a perfect spiral due to the bending of the bag 10 along corresponding fold lines 74, 80. Preferably, the sides 60 and 68 spiral inwardly in the same spiral counter-clockwise direction. Alternatively, the sides 60, 68 may spiral in the same clockwise direction or in opposite clockwise/counter-clockwise directions.

Next a releasable fastener in the form of perforated tape 82 is applied to the bag 10 in the fourth folded state so as to maintain the bag 10 in the fourth folded state for insertion into the container. The perforation in the tape 82 are positioned in non-contacting relation with the bag 10 so that the tape can tear along these perforations.

A further vacuum is then applied to the bag 10 in the preferred method. In accordance with this method, a folded bag 10 is achieved ready for insertion into a container.

Further, once inserted into the container the bag is permitted to expand by initially applying a pressure to the bag 10 through the neck portion 34 causing the perforated tape 82 to break. The bag 10 readily unravels without kinks by first unwinding the spiral sides and then expanding the branches. Accordingly, the present invention provides a folded bag able to be inserted through an aperture of a container that is able to expand when later filled with beverage.

What is claimed is:

1. A method of preparing a bag for insertion into a container, the bag comprising two panels and a neck portion passing between the panels, the neck portion having a spear portion extending into the bag between the panels, the method comprising the steps of:
a) folding the bag into a first folded state by folding each of the panels along a plurality of fold lines that extend orthogonal to the spear;
b) folding the bag into a second folded state by folding a first side of the bag in the first folded state inwards over itself in a first spiral-like manner in a plurality of fold sections along fold lines extending parallel to the spear;
c) folding the bag into a third folded state by folding a second side of the bag in the second folded state inwards over itself in a second spiral-like manner in a plurality of fold sections along fold lines extending parallel to the spear; and,
d) applying a releasable fastener to the bag in the third folded state so as to maintain the bag in the third folded state for insertion into the container.

2. The method of claim 1 further including the step of applying a vacuum to the bag through the neck portion to evacuate the bag.

3. The method of claim 1 wherein, prior to folding the bag into a second folded state, folding corners of a first side of the bag in the first folded state into the center of the bag to form two triangle flaps having adjacent side walls.

4. The method of claim 3 wherein, prior to folding the bag into a second folded state folding corners of a second side of the bag in the first folded state into the center of the bag to form an additional two triangle flaps having adjacent side walls.

5. The method of claim 4 wherein, during the step of folding the bag into the first folded state, each of the panels has a plurality of folded branches that partially overlap adjacent branches.

6. The method of claim 5 wherein each of the panels has a first folded branch closely adjacent the neck portion.

7. The method of claim 4 wherein the spear extends adjacent a bottom portion of the bag when in the first folded state.

8. The method of claim 4 wherein the releasable fastener comprises perforated tape where tape perforations are non-contacting with the bag.

9. The method of claim 4 wherein the first and second spiral-like manners spiral in the same direction.

10. A method of preparing a bag for insertion into a container, the bag comprising two panels and a neck portion passing between the panels, the neck portion having a spear portion extending into the bag between the panels, the method comprising the steps of:
a) positioning the bag with the panels in adjacent position;
b) applying a vacuum through the neck portion to partially evacuate the bag;
c) folding the bag into a first folded state by folding each of the panels along a plurality of fold lines that extend orthogonal to the spear;
d) applying a further vacuum to the bag through the neck portion to further evacuate the bag;
e) folding the bag into a second folded state by folding corners of a first side of the bag in the first folded state into the center of the bag to form two triangle flaps having adjacent side walls;
f) folding the bag into a third folded state by folding the first side of the bag in the second folded state inwards over itself in a first spiral-like manner in a plurality of fold sections along fold lines extending parallel to the spear;
g) folding the bag into a fourth folded state by folding a second side of the bag inwards over itself in a second spiral-like manner in a plurality of fold sections along fold lines extending parallel to the spear;
h) applying a releasable fastener to the bag in the fourth folded state so as to maintain the bag in the fourth folded state for insertion into the container; and,
i) applying a further vacuum to the bag.

11. The method of claim 10 wherein, during the step of folding the bag into the first folded state, each of the panels has a plurality of folded branches that partially overlap adjacent branches.

12. The method of claim 11 wherein each of the panels has a first folded branch closely adjacent the neck portion.

13. The method of claim 10 wherein the spear extends adjacent a bottom portion of the bag when in the first folded state.

14. The method of claim 10 wherein the step of applying a further vacuum to the bag through the neck portion to further evacuate the bag to a pressure of −0.7 bar.

15. The method of claim 10 wherein the step of folding the bag into a second folded state further includes the step of folding corners of a second side of the bag into the center of the bag to form an additional two triangle flaps having adjacent side walls.

16. The method of claim 10 wherein the releasable fastener comprises perforated tape where tape perforations are non-contacting with the bag.

17. The method of claim 10 wherein the first and second spiral-like manners spiral in the same direction.

18. A folded bag adapted for insertion into a container, the bag comprising two panels and a neck portion passing between the panels, the neck portion having a spear portion extending into the bag between the panels, the bag comprising:
a first plurality of folds on each of the panels extending orthogonal to the spear;
a first side of the bag being folded inwards over itself in a first spiral-like manner in a plurality of fold sections along fold lines extending parallel to the spear; and,
a second side of the bag being folded inwards over itself in a second spiral-like manner in a plurality of fold sections along fold lines extending parallel to the spear.

19. The bag of claim 18 further including a releasable fastener at least partially surrounding the bag for maintaining the bag in its folded state for insertion into the container.

20. The bag of claim 19 wherein the first and second spiral-like manner extend in the same direction.

21. A folded bag adapted for insertion into a container, the bag comprising two panels and a neck portion passing between the panels, the neck portion having a spear portion extending into the bag between the panels, the bag comprising:
a first plurality of folds on each of the panels extending orthogonal to the spear;
two folded corners on each of first and second sides of the bag folded into the center of the bag to form two triangle flaps on each of the first and second sides having adjacent side walls;
the first side of the bag being folded inwards over itself in a first spiral-like manner in a plurality of fold sections along fold lines extending parallel to the spear; and,
a second side of the bag being folded inwards over itself in a second spiral-like manner in a plurality of fold sections along fold lines extending parallel to the spear.

22. The bag of claim 21 further including a releasable fastener at least partially surrounding the bag for maintaining the bag in its folded state for insertion into the container.

23. The bag of 21 wherein the first plurality of folds on each of the panels comprise a plurality of folded branches that partially overlap corresponding branches.

24. The bag of claim 23 wherein each of the panels has a first folded branch closely adjacent the neck portion.

25. The bag of claim 21 wherein the spear extends adjacent a bottom portion of the bag.

26. The bag of claim 21 wherein the releasable fastener comprises perforated tape where tape perforations are non-contacting with the bag.

27. The bag of claim 21 wherein the first and second spiral-like manners spiral in the same direction.
